(19) United States
(12) Patent Application Publication
(10) Pub. No.: US 2013/0086082 A1
(43) Pub. Date: Apr. 4, 2013

(54) METHOD AND SYSTEM FOR PROVIDING PERSONALIZATION SERVICE BASED ON PERSONAL TENDENCY

(71) Applicants: Samsung Electronics Co., Ltd., Gyeonggi-do (KR); POSTECH Academy-Industry Foundation, Gyeongsangbuk-do (KR)

(72) Inventors: Seungtaek Park, Hwaseong-si (KR); Hyungdong Lee, Seoul (KR); Jinoh Oh, Pohang-si (KR); Hwanjo Yu, Pohang-si (KR); Sun Park, Pohang-si (KR)

(73) Assignees: POSTECH Academy-Industry Foundation, Gyeongsangbuk-do (KR); Samsung Electronics Co., Ltd., Gyeonggi-do (KR)

(21) Appl. No.: 13/630,493

(22) Filed: Sep. 28, 2012

(30) Foreign Application Priority Data
Sep. 29, 2011 (KR) 10-2011-0099314

(51) Int. Cl. G06F 17/30

(52) U.S. Cl. 707/748; 707/E17.005

(57) ABSTRACT

A personalization recommendation service providing method and system, based on a personal tendency provides a personally targeted recommendation list by re-ranking a candidate recommendation list obtained through a predetermined recommendation technique, by acquiring a user tendency profile and the candidate recommendation list, re-ranking the candidate recommendation list according to the user tendency profile, and generating the targeted recommendation list based on recommendation contents by the re-ranking of the candidate recommendation list.

### PRIORITY

This application claims priority under 35 U.S.C. §119(a) to a Korean patent application filed on Sep. 29, 2011 in the Korean Intellectual Property Office and assigned Serial No. 10-2011-0099314, the entire disclosure of which is incorporated herein by reference.

### BACKGROUND OF THE INVENTION

1. Field of the Invention

The present invention relates generally to a method and system for providing a personalization service associated with recommendation, advertisement, search, and the like and, more particularly, to a personalization service providing a method and system based on a personal tendency which allows providing a personally targeted recommendation service to each user by reprocessing a primary recommendation result about recommendations, advertisements, searches, or the like, depending on a user's personal tendency.

2. Description of the Related Art

The Internet is an open network that enables anyone, located anywhere in the world, to freely access a desired server/client, using a Transmission Control Protocol/Internet Protocol (TCP/IP) and to use various services such as transmission of text information and multimedia information services, e-mail services, file transfer services, and various other services available on the World Wide Web.

As worldwide use of Internet increases rapidly, the Internet not only becomes much more important as a strategic tool for enhancing efficiency and productivity in many industrial fields, but also continuously offers new business opportunities. For example, a great number of web sites have been used to provide various content such as Internet advertisement, Internet broadcasting, online gaming, Internet news/magazine, search service, portal service, e-commerce, and the like.

In order for users to save time in finding their desired information, some sites have recently offered personalized services that would allow users to edit the main access page to their tastes and to selectively obtain information suitable to their styles. For example, a client user who conducts a member registration at a specific site provides information regarding their favorite page format and color or areas of interest to that site. In response, the site provides the main page in a specific format selected by the user or with information suitable for the user. Such typical personalized services have been widely used in sites providing information or associated with e-commerce.

However, such personalized services typically fail to provide a functionality to infer a user's preference and interest related to frequency and time in using information or to infer user's tendency related to purchase records. Further, when more information items are required from the user in order to implement a more enhanced personalized service, the user's insincere input will cause a failure in providing relevant information to that user.

To solve the above-described problems, a collaborative filtering technique based on user's behavior has been proposed. User-to-user (also referred to as K-Nearest Neighbor (KNN)) collaborative filtering technique or item-based (also referred to as item KNN) collaborative filtering techniques may used. The former technique is used is to find other users having similar purchase or behavior patterns to a target user and then to recommend content that is popular with such a group of users but not yet purchased by the target user. The latter is to grasp similarity of content from purchase patterns of users and then to recommend contents that are similar to the purchased content. However, this collaborative filtering technique has several shortcomings in recommending similar content.

Specifically, in typical personalized services, although each piece of information contributes to the resulting recommendation, and the advertisement or searching patterns reflects the user's preference, this information list as a whole may not sufficiently reflect the user's tendency. For example, for a user who likes both comedy films and science fiction films, the personalized service recommends a list containing A, B and C to the user, where each of A, B and C of the list is considered interesting or suitable information for the user. However, while all of A, B and C may generally belong to a very similar category (e.g., a science fiction film), such a recommendation list does not reflect all of user's preferences, but merely the stronger preferences. Thus, the recommendation result will not contain a mixed recommendation of a comedy film and a science fiction film.

Similarly, typical personalized services may recommend widespread information which may probably be known to the user (e.g., movie, music, news, broadcasting, gaming, goods, etc.) rather than interesting information which may appeal to the user. This may cause a lack of uniqueness or variety in recommendation. In order to remedy this problem, some approaches to automatically increase uniqueness or variety have been considered. For example, when recommending five content items, fifty recommendation candidates are first picked, and then five content items which are most significantly different from the others are selected among fifty candidates. However, this approach may often fail to meet the needs or demands of some users having relatively narrower preferences since uniqueness or variety is automatically increased without considering a user's personal preference.

### SUMMARY OF THE INVENTION

Accordingly, the present invention has been made in view of the above-mentioned problems and/or disadvantages, and according to one aspect of the present invention, there is provided a personalization service providing method and system based on a personal tendency, which allows providing a personally targeted recommendation service depending on user's personal tendency.

According to another aspect of the present invention there is provided a personally targeted recommendation service by reprocessing a general candidate recommendation result (i.e., personalized or non-personalized recommendation information) based on a user's personal tendency.

According to still another aspect of the present invention there is provided an enhancement of user satisfaction of recommendation by increasing or decreasing a particular tendency (i.e., through uniqueness or variety) in the recommendation based on a user's personal tendency.

According to yet another aspect of the present invention there is provided targeted recommendation information, which is well suited to user's tendency, through reprocessing of personalized or non-personalized candidate recommendation information based on a user's personal tendency.

According to one aspect of the present invention, there is provided a method for providing a personalization recommendation service, the method including acquiring a user tendency profile and a candidate recommendation list, re-ranking the candidate recommendation list according to the user tendency profile, and generating a targeted recommendation list based on recommendation contents by the re-ranking of the candidate recommendation list.

According to another aspect of the present invention, there is provided a system for providing a personalization recommendation service which includes a server Application Programming Interface (API) configured to receive an event for a targeted personalization service from a client, a user profile generator configured to generate a user tendency profile based on user information according to the event and metadata of contents, and a recommendation engine configured to generate a candidate recommendation list based on the user tendency profile and then to generate a targeted recommendation list by re-ranking the candidate recommendation list based on the user tendency profile.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating the configuration of a personalization service providing system based on a personal tendency according to an embodiment of the present invention;

FIG. 2 is a block diagram illustrating the configuration of a service server according to an embodiment of the present invention;

FIG. 3 is a flow diagram illustrating a process of providing a personalization service based on a personal tendency at a service server according to an embodiment of the present invention;

FIGS. 4A to 5C are diagrams illustrating a personalization service according to an embodiment of the present invention;

FIG. 6 is a flow diagram illustrating a method for supporting a personalization service based on a personal tendency at a service server according to an embodiment of the present invention; and

FIG. 7 is a flow diagram illustrating a method for re-ranking a candidate recommendation list at a service server according to an embodiment of the present invention.

### DETAILED DESCRIPTION OF EMBODIMENTS OF THE PRESENT INVENTION

Various embodiments of the present invention are described in detail with reference to the accompanying drawings. Well known techniques, elements, structures, and processes will be omitted to avoid obscuring the subject matter of the present invention. The drawings and certain elements illustrated within the drawings are not necessarily to scale and certain features may be exaggerated or omitted.

According to an aspect of the present invention, there is provided a method and system for providing a personally targeted service, based on a personal tendency, which can recommend a variety of contents associated with recommendation, advertisement, search, and the like, depending on a user tendency. Further, one aspect of the present invention provides post-processing based personalization technology which can be widely used in recommendation, advertisement, search, and the like. According to an aspect of the present invention, a primary candidate recommendation result about personalized or non-personalized content is obtained through a predetermined recommendation technique and then re-ranked based on a user tendency. Thus, a secondary targeted recommendation result is provided to support a personalized recommendation service which is much more optimized to user's personal tendency.

According to an embodiment of the present invention, a user tendency profile is generated based on user information and metadata of content, and a candidate recommendation result, primarily recommended by a personalization/non-personalization recommendation technique, is compared with the user tendency profile. Thus, a much more personally targeted recommendation result by reprocessing (e.g., re-ranking) the candidate recommendation result according to the user tendency profile is obtained, and a much more enhanced personalization recommendation service is provided, by outputting the targeted result to a client.

In the following description, content refers to many types of contents such as movies, music, news, broadcasting, gaming, searching, advertisement, e-commerce, and e-mail, which can be used through access to a service server. Metadata refers to various kinds of service information (for example, a title, a genre, a release date, a running time, a director, actors, and the like, of a movie) registered for each content item.

User information refers to history information associated with user's behavior or any other information created by user's behavior for such content, including user's demographic data, user's consumption history, user's favorites list, user's bookmark list, user's viewing history, user's click history, user's friend list, and user friend's interaction content list. Furthermore, a user tendency profile is represented as one or more user tendency distributions relating to variety, uniqueness, newness, genre, social intimacy (i.e., consuming inclination for specific contents consumed by friends), popularity, and the like.

A candidate recommendation result (or list) refers to a primarily recommended result (or list) using a predetermined recommendation technique, including a personalization or non-personalization recommendation technique, used for personalization recommendation services.

A personalization recommendation technique includes a collaborative filtering technique, a content-based filtering technique, and a hybrid filtering technique of both techniques. A collaborative filtering technique functions to extract users having similar behavior patterns to a target user, and then to rank contents or their items (the target user would like) by using a common preferred pattern in a group of the extracted users. A content-based filtering technique functions to find particular features frequently appearing in content or content items consumed by the target user, and then to rank these contents.

A non-personalization recommendation technique includes a most popular technique, a most recent technique, a random selection technique, and the like.

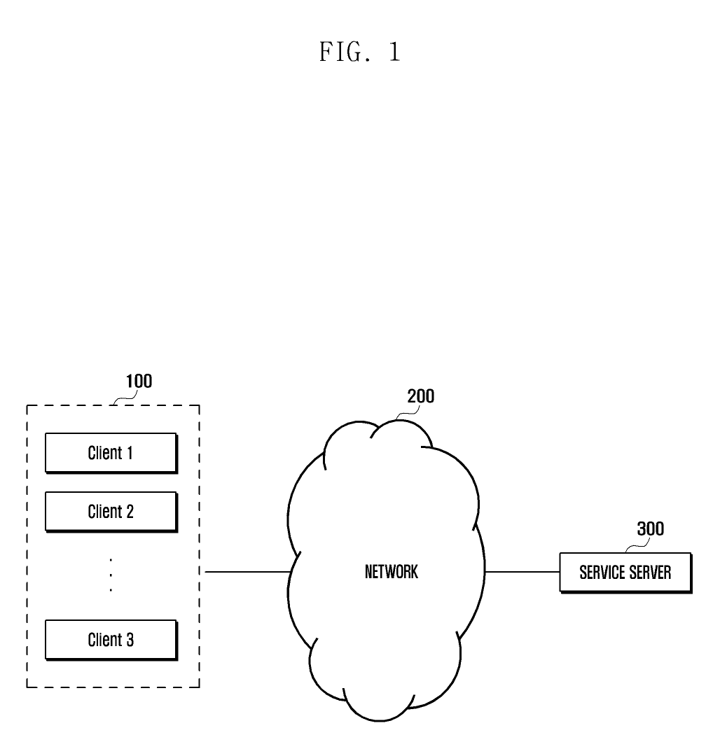

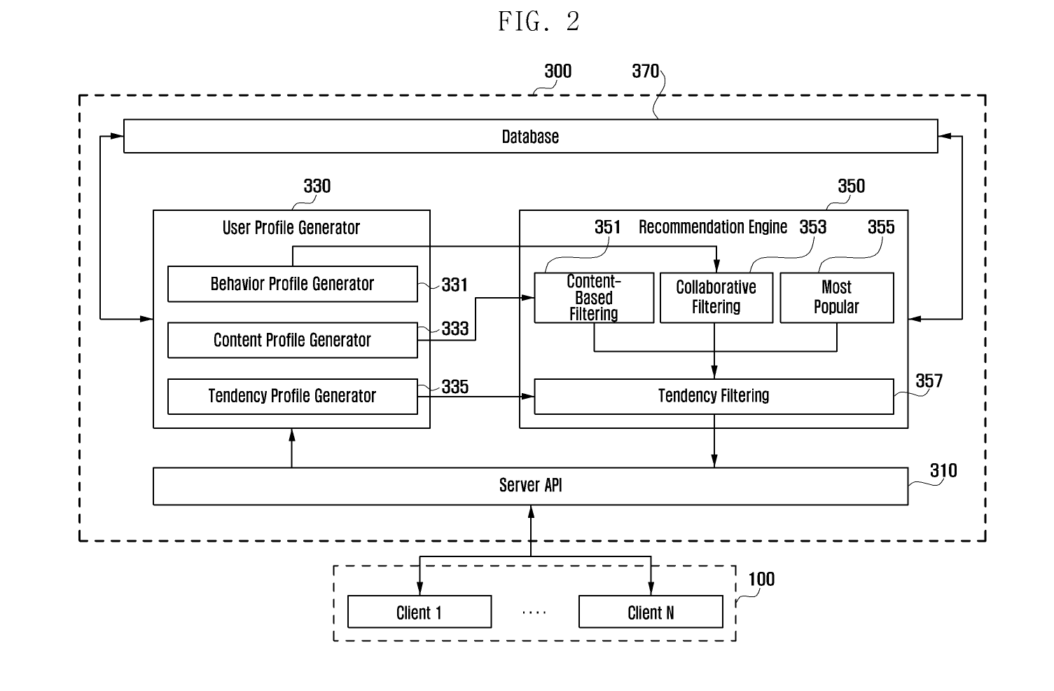

FIG. 1 is a diagram illustrating the configuration of a personalization service providing system based on a personal tendency according to an embodiment of the present invention.

Referring to FIG. 1, the personalization service providing system includes a plurality of clients 100, a network 200, and a service server 300.

The network 200 supports various communications such as wired or wireless Internet. The network 200 offers a communication line between the clients 100 and the service server 300, thus allowing a data communication associated with a personalization service between them.

Each of the clients 100 constructs a communication environment for an access to the service server 300 that provides a personalization service established in the network 200. After an access to the service server 300, the client 100 sends user information inputted by the user to the service server 300 in order to use a personalization service, receives personalization service data (e.g., a recommendation list, recommendation information) of a specific user from the service server 300, and then displays the received data on the screen.

The service server 300 has database that contains data newly created on the Web for categories classified by an administrator. The network 200 constructs a database that contains user information for a personalization service inputted at the clients 100 by users and classified according to user.

Specifically, the service server 300 generates a user tendency profile based on user information and content metadata, and extracts a candidate recommendation result (or a candidate recommendation list) by using a personalization or non-personalization technique. Additionally, the service server 300 compares the extracted candidate recommendation result with the user tendency profile, and generates a targeted recommendation result (or a targeted recommendation list) by re-ranking the candidate recommendation result according to the user tendency profile. Further, the service server 300 sends such a personally targeted recommendation result to a relevant client.

The service server 300 analyzes relevant user information, based on event information created by a user, content satisfaction of each category, search keywords, and predetermined rules. Then the service server 300 generates new targeted personalization information by combining the analyzed user information with previously stored service information (i.e., a candidate recommendation result). The service server 300 may draw a targeted recommendation result by comparing the candidate recommendation result with the user tendency profile through the Earth Mover's Distance (EMD), as discussed below. Additionally to using the EMD, other known ways of measuring a difference between two distributions may be used to compare the candidate recommendation result with the user tendency profile.

According to an embodiment of the present invention, the service server 300 extracts a candidate recommendation result (i.e., personalization recommendation information) by using a collaborative filtering technique, a content-based filtering technique, a hybrid filtering technique, and the like, as discussed above. Also, the service server 300 extracts a candidate recommendation result (i.e., non-personalization recommendation information) by using a most popular technique, a most recent technique, a random selection technique, etc. based on demographic data. In addition to the above techniques, other various techniques that can support a personalization or non-personalization recommendation service may be used to extract a candidate recommendation result (i.e., personalization service information, non-personalization service information).

Although not illustrated in FIG. 1, the system may further include a recommendation server with the service server 300 supporting the communication between the client 100 and the recommendation server, and personalization service functionality of the service server 300 may be performed at the recommendation server.

FIG. 2 is a block diagram illustrating the configuration of a service server according to an embodiment of the present invention.

As illustrated in FIG. 2, the service server 300 includes a server API 310, a user profile generator 330, a recommendation engine 350, and a database 370. The user profile generator 330 includes a behavior profile generator 331, a content profile generator 333, and a tendency profile generator 335. The recommendation engine 350 includes a content-based filtering engine 351, a collaborative filtering engine 353, a most popular engine 355, and a tendency filtering engine 357.

Referring to FIGS. 1 and 2, the user sends a request for a personalized recommendation service to the service server 300 through the client 100. This request for a recommendation service is made when the user accesses the service server 300 through the client 100 and then logs in, when there is a selection of contents provided by the service server 300, or when the user logs in the service server 300 and then requests service information about specific content. That is, all cases in which there occurs an event for providing a targeted personalization service to the user may be applied.

The service server 300 detects the occurrence of an event for providing a targeted personalization service from the client 100 through the server API 310. When detecting any event through the server API 310, the service server 300 provides user information (i.e., history data and data created through user behavior) associated with the detected event to the user profile generator 330 and then generates a user tendency profile about the event through the user profile generator 330. Here, the user profile generator 330 includes one or more profile generators to generate a user tendency profile. For example, the user profile generator 330 may include the behavior profile generator 331, the content profile generator 333, and the tendency profile generator 335, thereby generating a user tendency profile originated from the event among the whole information related to the user, such as user's demographic data, user's consumption history, user's favorites list, user's bookmark list, user's viewing history, user's click history, user's friend list, and user friend's interaction content list, as described below.

After the user profile generator 330 generates a user tendency profile, the service server 300 may generate at the recommendation engine 350 a candidate recommendation list for a relevant user based on the generated user tendency profile. Here, the recommendation engine 350 may generate the candidate recommendation list, using at least one engine such as the content-based filtering engine 351, the collaborative filtering engine 353, the most popular engine 355, and the like. Specifically, the recommendation engine 350 includes an engine for a personalization type recommendation and an engine for a non-personalization type recommendation. One or more candidate recommendation lists may be generated using a filtering technique for recommending content candidates. For example, a number of candidate recommendation lists may be provided according to categories (e.g., box offices) about a specific content type (e.g., movie).

After the recommendation engine 350 generates the candidate recommendation list, the service server 300 may generate a targeted recommendation list by reprocessing (e.g., re-ranking) the candidate recommendation list based on a user tendency profile. Here, the recommendation engine 350 may perform a reprocessing of the candidate recommendation list, using the tendency filtering engine 357. That is, based on a user tendency profile and using the tendency filtering engine 357, the recommendation engine 350 may re-rank recommendation contents in the candidate recommendation list. In the case of two or more candidate recommendation lists, the tendency filtering engine 357 may collect all the lists and then perform a re-ranking with regard to the whole lists according to a user tendency profile. Also, the tendency filtering engine 357 may generate a re-ranked, targeted recommendation list. Here, the tendency filtering engine 357 may form a targeted recommendation list that recommends the selected number (K which is a natural number) of top results among re-ranked recommendation results.

Next, the service server 300 may extract metadata, required for contents (or items therein) recommended by the targeted recommendation list, from the database 370 and then deliver the extracted metadata to the client 100. Using this metadata, the client 100 may display a scene or page recommended by the targeted recommendation list.

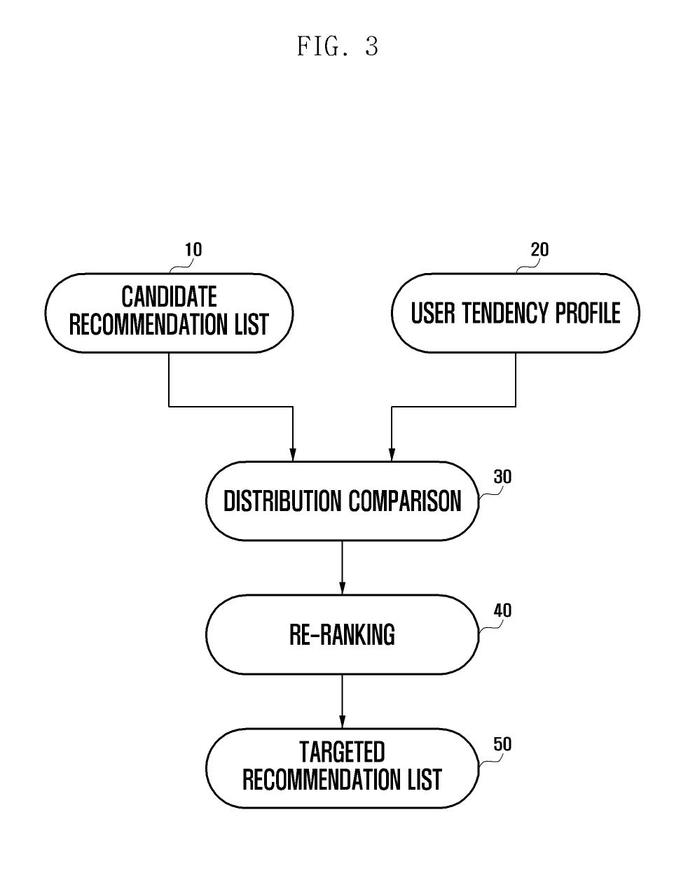

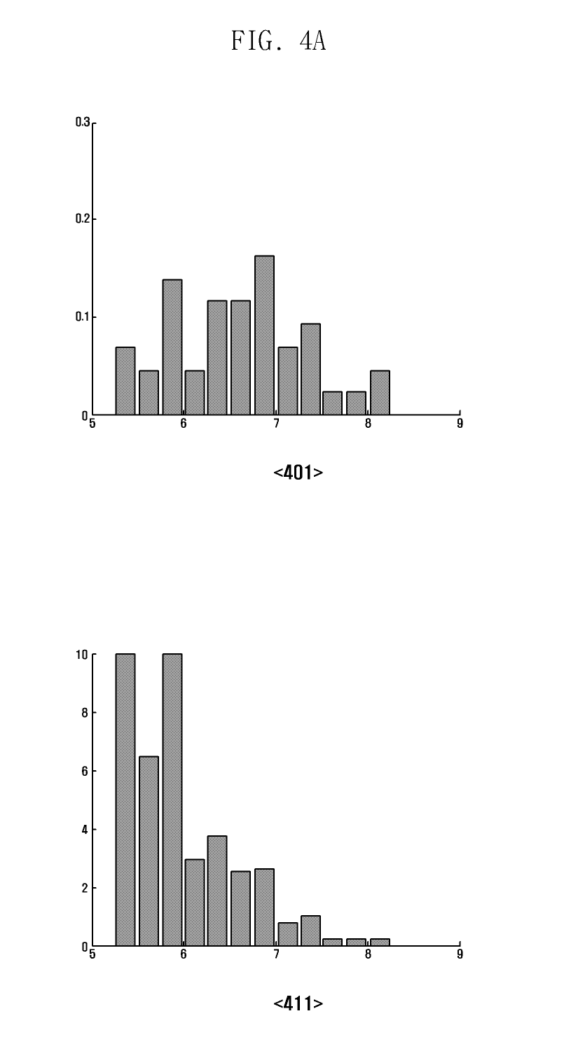

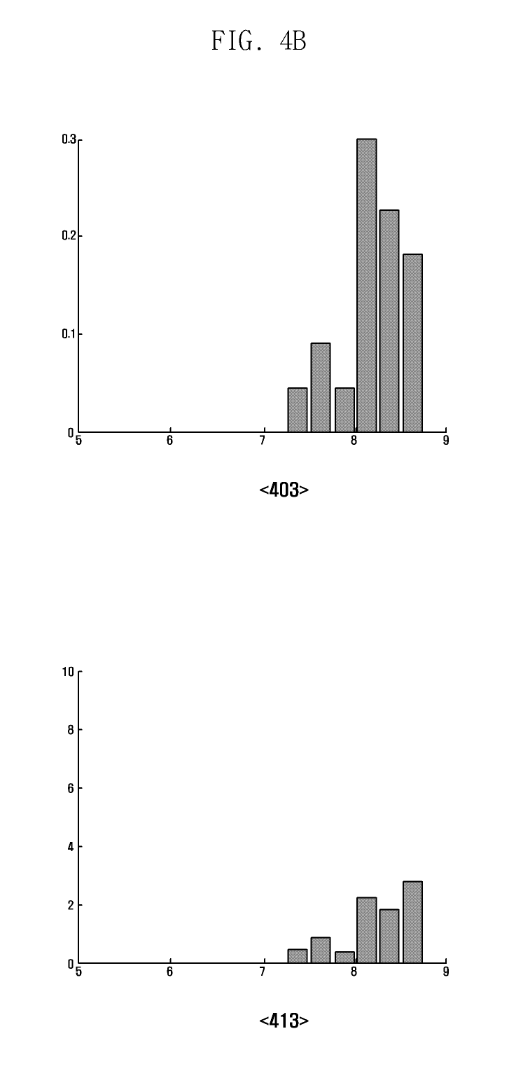

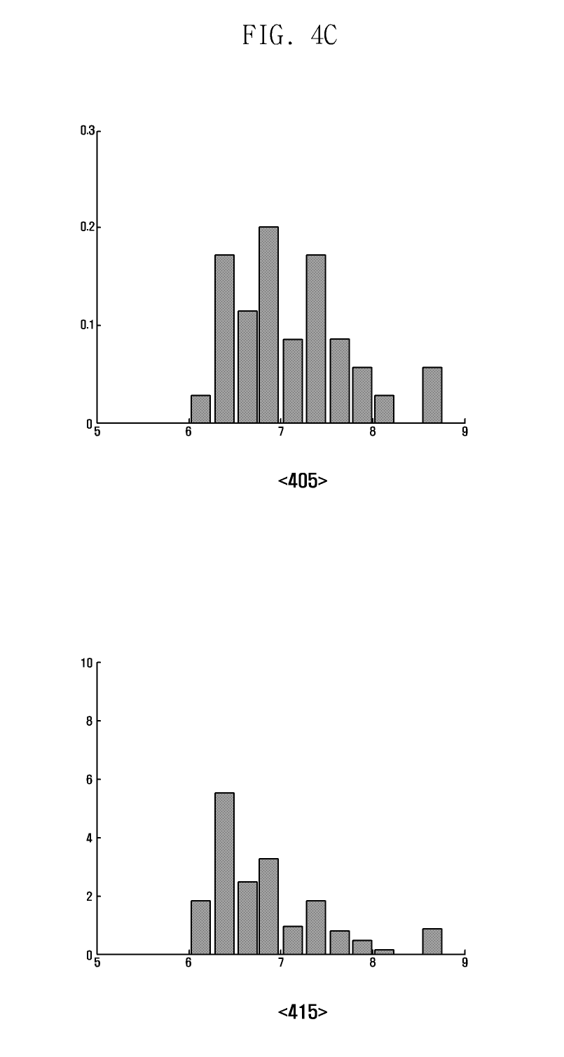

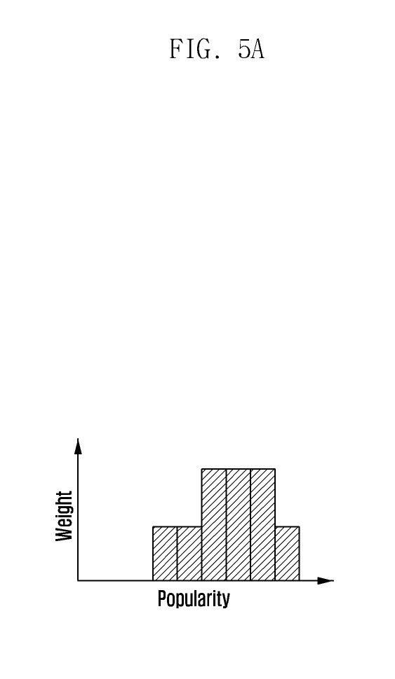

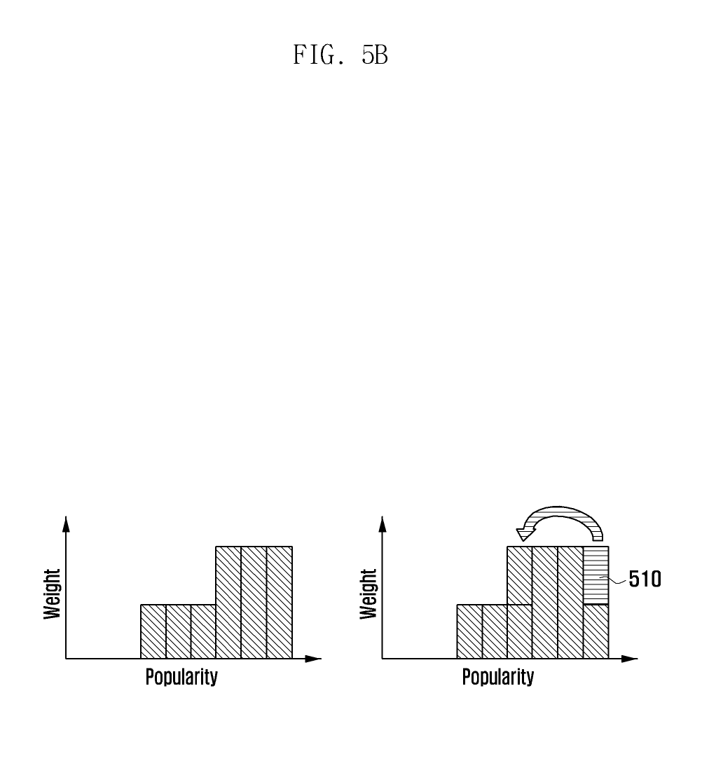

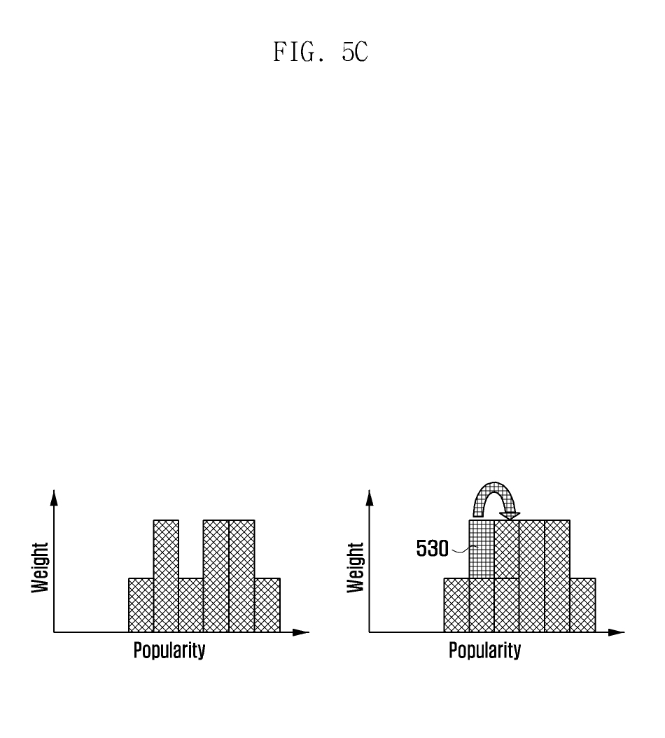

FIG. 3 is a flow diagram illustrating a process of providing a personalization service based on a personal tendency at a service server according to an embodiment of the present invention. FIGS. 4A to 5C are diagrams illustrating a personalization service according to an embodiment of the present invention. FIGS. 4A to 4C show examples of a user tendency profile based on a used history of specific content, and FIGS. 5A to 5C show examples of a measurement of EMD distance between distributions in the user tendency profile and the candidate recommendation list.

As illustrated in FIG. 3, a targeted recommendation list is generated based on a personal tendency of each user by re-ranking, based on a user tendency profile, a candidate recommendation list based on user information, and then support a personally targeted recommendation service through the targeted recommendation list based on a personal tendency. Thus, according to an embodiment of the present invention, the method may include three main steps as follows: generating a user tendency profile based on a user tendency, comparing the user tendency profile with a tendency distribution in a candidate recommendation list, and generating a targeted recommendation list by re-ranking the candidate recommendation list based on the user tendency profile.

The candidate recommendation list may be provided using a personalization recommendation technique such as a collaborative filtering technique, a non-personalization recommendation technique such as a most popular technique, a randomly recommendation technique, and the like. Described hereinafter are generating a candidate recommendation list by calculating a Preference Score (PS) about user content through a collaborative filtering technique, re-ranking the generated candidate recommendation list so as to become similar with a user tendency profile as much as possible, and then selecting and recommending top-ranked K contents.

Referring to FIGS. 3 to 5C, at the outset, the service server 300 may acquire a candidate recommendation list (i.e., draw a previously generated candidate recommendation list or generate a new candidate recommendation list based on user information) associated with the user through a personalization or non-personalization recommendation manner as discussed above and indicated by a reference number 10.

Additionally, as indicated by a reference number 20, the service server 300 may generate a user tendency profile. Here, the service server 300 may generate a user tendency profile, depending on history/records (e.g., box office information, genre information, newness information, price, date, etc.) of contents (e.g., movie, music, mail, news, advertisement, e-commerce, etc.) used (e.g., watched, listened, purchased, etc.) by the user. Such a user tendency profile may be represented as a distribution graph as illustrated in FIGS. 4A to 4C. Hereinafter, in a case where content is movie, a method for generating a user tendency profile about movie tendencies (e.g., user's movie-going tendency profile) will be described with reference to FIGS. 4A to 4C.

As illustrated in FIGS. 4A to 4C, a user tendency profile may be represented as user's movie-going tendency distribution, based on box office information, genre information, newness information, etc. of movie watched by the user, and may also be composed of one or more user's movie-going tendency distributions. Examples illustrated in FIGS. 4A to 4C show user tendency profiles (often referred to as PPT (personal popularity tendency)) based on the distribution of box office information about movies watched by respective users. In FIGS. 4A to 4C, the horizontal axis denotes logarithmic box-office receipts, and the vertical axis denotes percentage of movies belonging to relevant range among movies watched by the user. Reference numbers 401, 403 and 405 respectively indicate box office distributions of movies watched by three users, and reference numbers 411, 413 and 415 indicate normal distributions of the above-mentioned box office distributions 401, 403 and 405 in the whole movies. For example, a reference number 401 in FIG. 4A indicates a box office distribution of movies watched by a certain user, and a reference number 411 indicates a normal distribution of the box office distribution 401 in the whole movies.

Returning to FIG. 3, the service server 300 may compare a tendency distribution of a candidate recommendation list with one of a user tendency profile as indicated by a reference number 30. A detailed method is as follows.

In order to re-rank recommended candidates contained in a candidate recommendation list, a difference in distribution between a user tendency profile and a candidate recommendation list is measured first. As discussed below, the EMD may be used for such measurement. However, any other methods capable of measuring a difference of two distributions may also be used. A distribution may be considered as a state where a number of particles are placed in an arbitrary shape.

From this viewpoint, any distribution may be changed to other shaped distribution by moving the arrangement of particles. The EMD calculates the least expense required for equalizing two distributions, and this may be converted into a transportation problem. For example, let's suppose that two distributions P and Q are expressed as Equation (1). Then expense required for equalizing two distributions (i.e., total workload) may be defined as Equation (2).

$$\begin{matrix}P = \{ ( {x}_{1} , {w}_{{x}_{1}}^{p} ) , ( {x}_{2} , {w}_{{x}_{2}}^{p} ) , … , ( {x}_{m} , {w}_{{x}_{m}}^{p} ) \} , \\ Q = \{ ( {x}_{1} , {w}_{{x}_{1}}^{q} ) , ( {x}_{2} , {w}_{{x}_{2}}^{q} ) , … , ( {w}_{n} , {w}_{{x}_{n}}^{q} ) \} & Equation ( 1 ) \\ WORK ( P , Q , F ) = {\sum }_{i = 1}^{m} {\sum }_{j = 1}^{n} {f}_{ij} {d}_{ij} & Equation ( 2 )\end{matrix}$$

$${f}_{ij} \geq 0 , 1 \leq i \leq m , 1 \leq j \leq n$$

$${\sum }_{j = 1}^{n} {f}_{ij} \leq {w}_{{x}_{i}}^{p} , {\sum }_{i = 1}^{m} {f}_{ij} \leq {w}_{{x}_{j}}^{q} , {\sum }_{i = 1}^{m} {\sum }_{j = 1}^{n} {f}_{ij} = min ( {\sum }_{i = 1}^{m} {w}_{{x}_{i}}^{p} , {\sum }_{i = 1}^{m} {w}_{{x}_{j}}^{p} )$$

Here, fᵢⱼ denotes the amount of particles that move from xᵢ to xⱼ, and dᵢⱼ denotes the basis distance from xᵢ to xⱼ. Also, the entire flow F is defined as [fᵢⱼ]. Under these conditions, the EMD may define the least expense as Equation (3).

$${D}_{EMD} ( P , Q ) = {min}_{f} WORK ( PQR ) \qquad Equation ( 3 )$$

A method for measuring a distance between respective distributions of a candidate recommendation list and a user tendency profile is described below, with reference to FIGS. 5A to 5C.

FIG. 5A illustrates an example of a target distribution according to a user tendency profile of a target user. FIG. 5B illustrates an example of a candidate distribution of the first recommended candidates based on a candidate recommendation list. FIG. 5C illustrates an example of a candidate distribution of the second recommended candidates based on a candidate recommendation list. Assume that a distance between the target distribution of FIG. 5A and each of two candidate distributions of FIGS. 5B and 5C is measured. Then, in order to make the first recommended candidates be equal to the target distribution, a specific block 510 should be moved to a bin with low popularity as illustrated in FIG. 5B. Here, the total workload may be defined as the product of mass to be moved and distance to be moved. In FIG. 5B example, the total workload may be defined as the product of a block size and three.

Similarly, in order to make the second recommended candidates be equal to the target distribution, a specific block 530 should be moved to a bin with high popularity as illustrated in FIG. 5C. In two cases, the moved mass is similar, but a moved distance in the second recommended candidates is shorter than that in the first recommended candidates. In FIG. 5C example, the total workload may be defined as the product of a block size and one.

The above examples of FIGS. 5A to 5C illustrate, through EMD distance, that the second recommended candidates are relatively closer to the target distribution than the first recommended candidates. One advantage of such EMD is to allow considering the meaning of distance by adjusting the basis distance (dᵢⱼ). In the above examples, the basis distance may indicate a difference in the total logarithmic box-office receipts.

Returning to FIG. 3, the service server 300 may re-rank a candidate recommendation list based on a user tendency profile as indicated by a reference number 40, and thereby may generate a new targeted recommendation list for a targeted personalization service, according to an embodiment of the present invention. Now, a method for re-ranking recommended candidates (e.g., recommended contents) contained in a candidate recommendation list according to a user tendency profile will be described.

A re-ranking is to make a distribution of top-ranked K contents be closer to a user tendency profile as much as possible while maximizing the sum of user's preference scores about top-ranked K contents in recommended candidates. For example, if the sum of user's preference scores about top-ranked K contents is represented as

$${\sum }_{i}^{ } {p}_{i} * {z}_{i}$$

and if a difference in distribution between a user tendency profile and top-ranked K contents is represented as D_{EMD}(P, Q), an objective function of re-ranking algorithm may be defined as Equation (4).

$$max {\sum }_{i}^{ } {p}_{i} * {z}_{i} - {cD}_{EMD} ( P , Q ) \qquad Equation ( 4 )$$

Here, pᵢ denotes user's preference about content (i) found by a recommendation algorithm using a predetermined collaborative filtering technique, and zᵢ indicates one in a case where content (i) is contained in top-ranked K contents or indicates zero otherwise. Multi-objective programming is converted into a single object programming by performing a linear combination using two objective functions as a weight parameter (c) according to normal optimization methodology. If a weight parameter (c) is sufficiently high, a final result may nearly depend on the EMD distance. If a weight parameter (c) is sufficiently low, the EMD distance may not nearly affect a result. Therefore, a final result may be similar with a result of recommendation using the collaborative filtering technique.

Accordingly, in order to solve an optimization issue of an objective function, the present invention provides an effective algorithm based on a greedy technique. A proposed algorithm may include a seed set selection algorithm and a greedy selection algorithm. A seed set selection algorithm may be used for extracting a seed set without calculating EMD. A greedy selection algorithm may repeatedly extract new content until each distribution bin is full, or replace previous content through a greedy technique.

Contents belonging to a seed set in the first step may be an optimum result regardless of a weight parameter (c) according to a definition thereof. From this viewpoint, two conditions which should be satisfied by seed contents may be considered. That is, since a final result is top-ranked K contents when a weight parameter (c) is zero, the first condition that seed content should have a higher relation score to belong to top-ranked K may be determined. Also, if any content contributes to an increase in EMD distance even though having a much higher preference score, such content may not be selected when a weight parameter (c) is of a much greater value. Thus, the second condition that seed content should not contribute to an increase in EMD distance may be determined.

Here, unless a direct calculation is used, it is difficult to know how much the content affects a final EMD score. Thus, content which does not contribute to the EMD distance, based on a theoretical analysis about EMD is identified. This optimization issue may be converted into other issue similar with bin-packing problem. For example, let's suppose that each of K contents is selected one by one in an empty state and that a variation in EMD distance is monitored. Let's further suppose that outflow and inflow are defined at a viewpoint of moving particles of a popularity tendency distribution based on box office information in top-ranked K recommendations so as to have the equal distribution as user's watching tendency distribution.

Under this assumption, all bins are empty at first. Therefore, each bin requires the entrance of particles, and this may be interpreted as inflow. Only after the addition of contents in a certain bin removes the entire inflow, it may be changed to outflow. Thus, whenever content is selected, inflow decreases, a change is made from inflow to outflow, or outflow increases. Similarly, according as a flow is varied due to a continuous addition of contents, the EMD distance is also varied. In addition, according as inflow decreases, the number of particles to be moved is also reduced together with a reduction in EMD distance. Contrarily, according as outflow increases, the EMD distance is also increased. When inflow is changed to outflow, it is uncertain whether the EMD distance decreases or increases. Accordingly, a seed set is selected among top-ranked K items just until inflow is changed to outflow. One example of this seed set selection algorithm is illustrated by Algorithm (1).

```
Algorithm (1)
    Data: A item set I = {i₁, i₂ . . . , iₙ}, and a PPI of an
        active user
    Result: A seed set S.
$\begin{matrix}1 \\ 2 \\ 3 \\ 4 \\ 5 \\ \\ 6 \\ 7 \\ \\ 8\end{matrix} \begin{matrix}begin \\ ⌊ \begin{matrix}\begin{matrix}\begin{matrix}S ∅ \\ K = top \text{-} k items from I\end{matrix} \\ foreach {i}_{j} ∈ K do\end{matrix} \\ ⌊ \begin{matrix}\begin{matrix}b = the popularity bin of {i}_{j} \\ if {w}_{b}^{U} > {w}_{b}^{S} + \frac{1}{k} then\end{matrix} \\ ⌊ \begin{matrix}S S ⋃ {i}_{j} \\ {w}_{b}^{S} = {w}_{b}^{S} + \frac{1}{k}\end{matrix}\end{matrix}\end{matrix}\end{matrix}$
```

Here, w_{b}^{S} and w_{b}^{U} denote a seed set and user's watching history frequency, respectively, in the b-th bin. Since the total number of recommended contents is fixed to K, adding each piece of content exerts an influence of 1/K on inflow into the bin.

If any content is not contained in an optimum result, other contents having lower preference scores than that content among contents in the same bin may also not be contained in an optimum result. Therefore, there is no need for testing all combinations, and it is sufficient to select specific content that increases most an objective function until contents of K−|S| (here, |S| is the size of a seed set) are selected in consideration of contents having higher preference scores in each bin. However, there is no guarantee whether a result obtained by this simple greedy technique is optimum. Therefore, after obtaining a result by a greedy method, all cases of replacing selected contents with remaining contents are tested, and this is repeated at the end of recommendation. One example of this greedy selection algorithm is illustrated by Algorithm (2).

Algorithm (2)

```
    Data: B a set containing top k − |S| items for each
          bin, seed set S
    Result: The optimal solution R.
$\begin{matrix}1 \\ 2 \\ 3 \\ 4 \\ 5 \\ 6 \\ 7 \\ 8 \\ 9 \\ 10 \\ 11 \\ 12 \\ 13\end{matrix} \begin{matrix}begin \\ ⌊ \begin{matrix}R = S \\ for 1 to k - \vert S \vert do \\ ⌊ \begin{matrix}\begin{matrix}Item = {arg}_{i ∈ top ( B )} max Objective ( R ⋃ i ) \\ R = R ⋃ Item\end{matrix} \\ B = B - Item\end{matrix} \\ repeat \\ \vert \begin{matrix}\begin{matrix}( i , q ) = {arg}_{i ∈ top ( B ) , q ∈ R - S} max Objective ( R ⋃ i - q ) \\ if Objective ( R ⋃ i - q ) > Objective ( R ) then\end{matrix} \\ ⌊ \begin{matrix}R = R ⋃ i - q \\ B = B ⋃ q - i\end{matrix}\end{matrix} \\ until No change occurs on R \\ return R\end{matrix}\end{matrix}$
```

Here, top(B) denotes a set of K−|S| contents having higher scores in each bin, and Objective( ) denotes an objective function shown in Equation 4.

As discussed above, the service server 300 according to an embodiment of the present invention may generate a user tendency profile based on a user's tendency, re-rank a candidate recommendation list based on the user tendency profile through a comparison of a tendency distribution between the user tendency profile and the candidate recommendation list, and then generate a new targeted recommendation list based on a re-ranking of the candidate recommendation list. Additionally, by sending the targeted recommendation list to the client 100, the service server 300 may provide the user of service-requesting client with a targeted personalization service based on relevant user's tendency.

One example of a general operation for providing a personalization service based on a user tendency is described below.

At the outset, let's suppose that top-ranked twenty recommended content candidates having higher user preference scores are extracted using collaborative filtering technique, and that twenty recommended contents are distributed in five categories (namely, five popularity bins based on box office) as shown in Table 1.

TABLE 1

| b1 | b2 | b3 | b4 | b5 |
|---|---|---|---|---|
| 3.5 (I-11) | 5.4 (I-1) | 4.8 (I-3) | 5.0 (I-2) | 3.8 (I-9) |
| 2.7 (I-17) | 4.3 (I-5) | 4.4 (I-4) | 4.2 (I-6) | 3.3 (I-13) |
| 1.4 (I-18) | 4.1 (I-7) | 3.8 (I-8) | 3.6 (I-10) | 2.9 (I-15) |
| | 3.5 (I-12) | 3.2 (I-12) | 2.8 (I-16) | 1.3 (I-19) |
| | | | 0.8 (I-20) | |

Table 1 shows a distribution of personal popularity tendency (PPT) bins based on box office and of user preference of top-ranked twenty recommended candidates. In each cell of Table 1, a left number denotes a Preference Score (PS) about a target user of content (e.g., movie). Contents are arranged in the PS order. For example, five recommendations are provided to a target user and the movies watched by the user have a Personal Popularity Tendency (PPT) as shown in Table 2. Here, an objective function is the same as Equation 4. Further, the weight parameter (c) is equal to one (c=1). Table 2 shows PPT distribution of films watched by such a target user.

TABLE 2

| | b1 | b2 | b3 | b4 | b5 |
|---|---|---|---|---|---|
| user's PPT | 0.05 | 0.3 | 0.3 | 0.3 | 0.05 |

Under the above assumption, a recommended seed set is determined using a seed set selection algorithm, as follows.

Since the number of recommended contents is five, the top-ranked five contents are tested to determine whether each of which is the topmost content of each category in Table 1 are contained in a seed set. Here, the effect of PPT in the final result caused by each piece of content may be fixed to 0.2 since a total of five contents are recommended. Additionally, in order for specific content to be contained in a seed set, an addition of such content should not make the weight of PPT in the final result be greater than that of PPT of a target user.

Therefore, each single piece of content of b2, b3 and b4 may be contained in a seed set. Since contents that satisfy the above conditions are I-1, I-2 and I-3, three pieces of contents may be selected as a seed set. Specifically, a seed set S may be represented as S={I-1, I-2, I-3}. Recommended PPT determined in this step may be represented as Table 3. Table 3 shows an example of a recommended seed set.

TABLE 3

| | b1 | b2 | b3 | b4 | b5 |
|---|---|---|---|---|---|
| user's PPT | 0.05 | 0.3 | 0.3 | 0.3 | 0.05 |
| recommended | 0 | 0.2 (I-1) | 0.2 (I-3) | 0.2 (I-2) | 0 |
| PPT | | | | | |

Then, by applying a greedy selection algorithm to the above recommended seed set, a finally recommended content set is determined.

An iterative selection may be performed as the first step of greedy selection. That is, this step selects any content that increases the value of an Objective Function (OF) to the maximum, while actually calculating EMD. Here, since three contents I-1, I-2 and I-3 are previously selected as a seed set, two contents are further required to reach five contents. Therefore, top-ranked two contents only are considered in each popularity bin, as shown in Table 4. That is, Table 4 shows a set of contents considered as recommendation candidates.

TABLE 4

| b1 | b2 | b3 | b4 | b5 |
|---|---|---|---|---|
| 3.5 (I-11) | 4.3 (I-5) | 4.4 (I-4) | 4.2 (I-6) | 3.8 (I-9) |
| 2.7 (I-17) | 4.1 (I-7) | 3.8 (I-8) | 3.6 (I-10) | 3.3 (I-13) |

Additionally, Table 5 shows an example of calculation results of an EMD value when the content of each bin is added. Specifically, Table 5 shows an example of EMD results when the fourth item is selected using a greedy selection algorithm.

TABLE 5

| | b1 | b2 | b3 | b4 | b5 | EMD | PS | OF |
|---|---|---|---|---|---|---|---|---|
| Target | 0.05 | 0.3 | 0.3 | 0.3 | 0.05 | | | |
| candidate4-1 | 0.2(I-11) | 0.2(I-1) | 0.2(I-3) | 0.2(I-2) | 0 | 2.0 | 18.7 | 16.7 |
| candidate4-2 | 0 | 0.4(I-1, 5) | 0.2(I-3) | 0.2(I-2) | 0 | 1.0 | 19.5 | 18.5 |
| candidate4-3 | 0 | 0.2(I-1) | 0.4(I-3, 4) | 0.2(I-2) | 0 | 1.0 | 19.6 | 18.6 |
| candidate4-4 | 0 | 0.2(I-1) | 0.2(I-3) | 0.4(I-2, 6) | 0 | 1.0 | 19.4 | 18.4 |
| candidate4-5 | 0 | 0.2(I-1) | 0.2(I-3) | 0.2(I-2) | 0.2(I-9) | 2.0 | 19 | 17 |

In Table 5, for example, a candidate 4-1 indicates a case where content of the first bin (b1) is added to a recommendation list. Similarly, a candidate 4-3 indicates a case where content of the third bin (b3) is added to a recommendation list. Adding one content in the first iteration results in a set of total of four contents, so the sum of weight becomes 0.8. However, EMD may be available even when the sum of weight is a different value. The EMD value indicates a lower bound of work load required when PPT of a target user is equal to PPT of recommendation. In the above example, additions of content to b2, b3 and b4 bins have the same value of EMD, and content that maximizes an objective function (namely, OF=PS−EMD) is I-4 (depending on PS of content). Thus, this content I-4 is selected in the first iteration step.

Table 6 shows an example of the same iterative step after the content I-4 is selected. In this example, since two cases of selecting an item from b2 and b4 bins have the same EMD value, the content that maximizes an Objective Function (OF) is I-5 which has a higher PS than I-6 has.

The result obtained using an iterative selection as the first step of a greedy selection is three contents of a seed set and two additionally selected contents. That is, a Recommendation content set (R) has I-1, I-2, I-3, I-4 and I-5 (R={I-1, I-2, I-3, I-4, I-5}).

Table 6 shows an example of EMD results when the fifth item is selected using a greedy selection algorithm.

TABLE 6

| | b1 | b2 | b3 | b4 | b5 | EMD | PS | OF |
|---|---|---|---|---|---|---|---|---|
| Target | 0.05 | 0.3 | 0.3 | 0.3 | 0.05 | | | |
| candidate5-1 | 0.2(I-11) | 0.2(I-1) | 0.4(I-3, 4) | 0.2(I-2) | 0 | 3.0 | 23.1 | 20.1 |
| candidate5-2 | 0 | 0.4(I-1, 5) | 0.4(I-3, 4) | 0.2(I-2) | 0 | 2.5 | 23.9 | 21.4 |
| candidate5-3 | 0 | 0.2(I-1) | 0.6(I-3, 4, 8) | 0.2(I-2) | 0 | 4.0 | 23.4 | 19.4 |
| candidate5-4 | 0 | 0.2(I-1) | 0.4(I-3, 4) | 0.4(I-2, 6) | 0 | 2.5 | 23.8 | 21.3 |
| candidate5-5 | 0 | 0.2(I-1) | 0.4(I-3, 4) | 0.2(I-2) | 0.2(I-9) | 3.0 | 23.4 | 20.4 |

Next, as the second step of a greedy selection, a content replacement may be performed. That is, since the above result of the first step in which contents are selected using a greedy technique may not be optimal, the second step tests whether a replacement of contents is optimal. Variations of EMD results for contents replacement are shown in Table 7. That is, Table 7 shows an example of EMD variations when content I-4 of b3 is replaced with other contents (I-11 of b1, I-7 of b2, I-6 of b4, and I-9 of b5).

TABLE 7

| | b1 | b2 | b3 | b4 | b5 | EMD | PS | OF |
|---|---|---|---|---|---|---|---|---|
| Target | 0.05 | 0.3 | 0.3 | 0.3 | 0.05 | | | |
| replace3-1 | 0.2(I-11) | 0.4(I-1, 5) | 0.2(I-3) | 0.2(I-2) | 0 | 6.0 | 23 | 17 |
| replace3-2 | 0 | 0.6(I-1, 5, 7) | 0.2(I-3) | 0.2(I-2) | 0 | 7.0 | 23.6 | 16.6 |
| replace3-3 | 0 | 0.4(I-1, 5) | 0.2(I-3) | 0.4(I-2, 6) | 0 | 2.0 | 23.7 | 21.7 |
| replace3-4 | 0 | 0.4(I-1, 5) | 0.2(I-3) | 0.2(I-2) | 0.2(I-9) | 3.0 | 23.3 | 20.3 |

In Table 7, for example, a replace 3-1 indicates a case where content (I-4) of the third bin (b3) is replaced with the next-ranked content (I-5) of the second bin (b2). Similarly, a replace 3-3 indicates a case where content (I-4) of the third bin (b3) is replaced with the next-ranked content (I-6) of the fourth bin (b4). In Table 7, the EMD distance in a case where content of b3 is replaced with content of b4 is 2.0 which is reduced by 0.5 in comparison with 2.5 before replacement. However, a difference in PS between content I-4 of b3 and content I-6 of b4 is merely 0.2 which is lowered than the above reduced value 0.5. Therefore, even though content having lower PS is selected, to reduce EMD lowers the value of OF. As a result, two contents are exchanged, so that a final recommendation content set (R) comes to have I-1, I-2, I-3, I-5 and I-6 (R={I-1, I-2, I-3, I-5, I-6}).

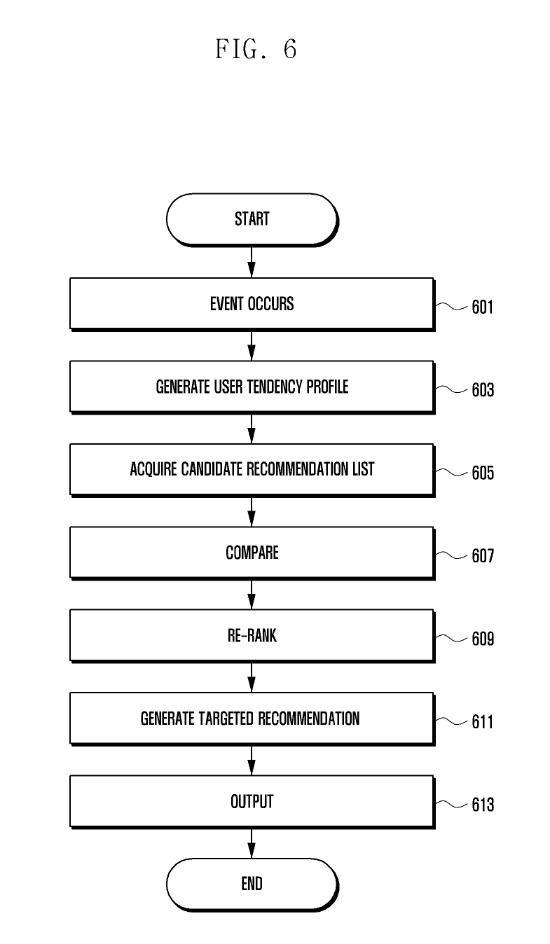

FIG. 6 is a flow diagram illustrating a method for supporting a personalization service based on a personal tendency at a service server according to an embodiment of the present invention.

Referring to FIG. 6, at the outset, the service server 300 may detect the occurrence of event for supporting a personalization service from the client 100 in Step 601. For example, when the user logs on the service server 300 by using the client 100, the service server 300 may recognize it as the occurrence of event for supporting a personalization service. Alternatively, when the user requests service information about specific content to the service server 300, the service server 300 may recognize it as the occurrence of event for supporting a personalization service.

Next, the service server 300 may generate a user tendency profile, depending on both user information according to the event and metadata of content according to the user information in Step 603. As discussed above, user information refers to history information associated with user's behavior or any other information created by user's behavior in such contents, including user's demographic data, user's consumption history, user's favorites list, user's bookmark list, user's viewing history, user's click history, user's friend list, and user friend's interaction content list. Furthermore, a user tendency profile may be represented as one or more user tendency distributions regarding user's variety, uniqueness, newness, genre, social intimacy, popularity, and the like.

Next, the service server 300 may acquire a candidate recommendation list for the user in Step 605. This acquisition of the candidate recommendation list may realized as extracting at least one candidate recommendation list previously registered for the user or newly generating at least one candidate recommendation list according to content of event. As discussed above, such a candidate recommendation list may be realized using a personalization recommendation technique such as a collaborative filtering technique or a content-based filtering technique, or a non-personalization recommendation technique such as a most popular technique. For example, when recommendation about specific content is required for the user accessing the service server 300, the service server 300 may extract top-ranked recommendation content candidates (e.g., top-ranked twenty movie contents for each box office) with higher PS by using at least one of given recommendation techniques and then, based on the extracted recommendation content candidates, construct a candidate recommendation list.

Next, the service server 300 may compare the user tendency profile with the candidate recommendation list in Step 607. Here, the service server 300 may compare a distribution of user tendency profile with a tendency distribution of candidate recommendation list, or measure a difference between a distribution of user tendency profile and a tendency distribution of candidate recommendation list by using the above discussed EMD.

Next, the service server 300 may re-rank the candidate recommendation list based on the user tendency profile in Step 609. In this step, the service server 300 may use a greedy technique to optimize a final recommendation list. Also, the service server 300 may use both a seed set selection algorithm for obtaining a seed set and a greedy selection algorithm for reaching a final recommendation list (e.g., top-ranked five) by iteratively selecting recommendation content candidates or replacing them with new ones, as further described below.

Next, the service server 300 may generate a targeted recommendation list, based on a set of finally recommended contents obtained from re-ranking of the candidate recommendation list in Step 611.

Next, the service server 300 may output the targeted recommendation list to the client 100 in Step 613. According to the above steps, the service server 300 may support a personally targeted service based on a personal tendency of client user.

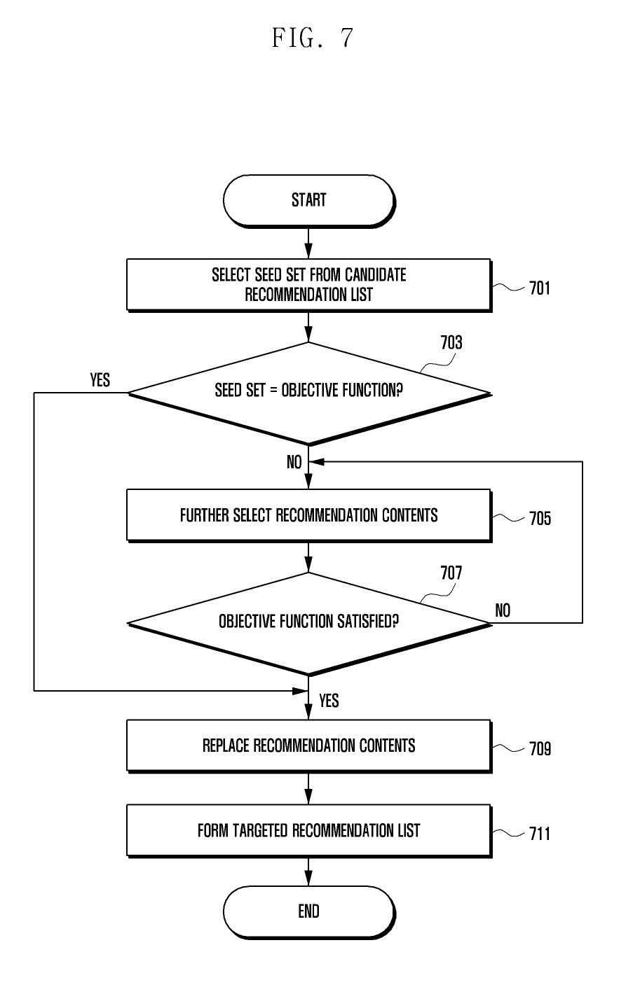

FIG. 7 is a flow diagram illustrating a method for re-ranking a candidate recommendation list at a service server according to an embodiment of the present invention.

Referring to FIG. 7, at the outset, the service server 300 may select a seed set of target recommended contents from a candidate recommendation list in Step 701. For example, the final recommendation contents may be the top five ranked contents (i.e., an objective function) in a candidate recommendation list containing top-ranked twenty content candidates having higher PS. Alternatively these top-ranked twenty contents may be classified into five categories (e.g., based on box office information). That is, a candidate recommendation list may include recommendation candidates in a plurality of categories. In this case, the service server 300 may perform a test for determining whether the topmost content of each category belongs to a seed set. That is, since final targeted recommendation contents are five, the service server 300 may determine whether each of topmost five contents satisfies given conditions (e.g., as discussed above, the weight of PPT in the final result should be lower than that of PPT of a target user.) and then select satisfying contents only. Also, the service server 300 may form a seed set from the selected recommendation contents. Specifically, the service server 300 forms a seed set based on a seed set selection algorithm.

Next, the service server 300 determines whether the number of recommendation contents in a seed set meets the objective function in Step 703. For example, the service server 300 may determine whether recommendation contents of a seed set include five content items indicated by the objective function.

If recommendation contents of a seed set correspond to the objective function (namely, the “YES” decision line of Step 703), the service server 300 performs Step 709, discussed below.

If recommendation contents of a seed set do not correspond to the objective function (namely, the “NO” decision line of Step 703), the service server 300 further selects additional contents from remaining recommendation content candidates in Step 705. For example, when a seed set has three contents, ten contents (i.e., two top-ranked contents in each of five categories) among remaining seventeen content are considered. Then the service server 300 selects optimal single content from ten contents in consideration of EMD. This step may be iteratively performed based on the number of contents required for a seed set.

After further selecting additional contents, the service server 300 determines whether the number of recommendation contents in a seed set meets the objective function in Step 707. If recommendation contents of a seed set do not correspond to the objective function, the service server 300 returns to Step 705. For example, if the number of recommendation contents in a seed set is four, the service server 300 performs a selection of content in order to reach five contents. Similarly, until the objective function is satisfied, the service server 300 performs an iterative selection by considering some contents having a higher PS in each category (e.g., five popularity bins based on box office) without a need of testing all combinations.

Next, the service server 300 performs a replacement for recommendation contents of a seed set in Step 709 and then, based on a set of final recommendation contents, form a targeted recommendation list in Step 711. For example, the service server 300 may test all replacement cases by comparing contents selected as a seed set with remaining contents, perform a replacement between contents in consideration of both EMD and PS, and then construct a targeted recommendation list from a targeted recommendation list. If there is no content to be replaced, the service server 300 forms a targeted recommendation list from a set of recommendation contents selected before Step 709. Specifically, the service server 300 performs the above-discussed further selection and replace based on a greedy selection algorithm.

The foregoing method and system for providing personalization service based on personal tendency may be implemented in an executable computer program instruction form by various computer means and be recorded in a computer readable recording medium. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions described above.

These computer program instructions may be stored in a computer usable or computer-readable recording medium that can direct a computer or other programmable data processing apparatus to function in a particular manner, such that the instructions stored in the computer usable or computer-readable memory produce an article of manufacture including instruction means that implement the functions described above.

The computer readable recording medium may include a program command, a data file, and a data structure individually or a combination thereof. In the meantime, the program command recorded in a recording medium may be specially designed or configured for the present invention or be known to a person having ordinary skill in a computer software field to be used.

The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands.

The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions described above. The computer implemented process may be implemented in a machine language code created by a complier and a high-level language code executable by a computer using an interpreter.

As described above, the present invention provides a personally targeted recommendation service based on user's personal tendency by increasing or decreasing particular characteristics in the recommendation based on a user's personal tendency. While the typical techniques at best automatically increase variety of recommendation information, aspects of the present invention enhance the satisfaction of all users having various preferences without reducing the satisfaction of some users having relatively narrower preferences. Additionally, aspects of the present invention may also be successfully applied to non-personalization recommendation such as demographic based popularity recommendation or random recommendation.

According to an aspects of the present invention, there is provided a personally targeted recommendation which is re-ranked based on a user's tendency with regard to personalized recommendation, advertisement, search, or the like. For example, an aspect of the present invention provides a system and method for recommendation of popular films among recommendation candidates (i.e., films the users would like) to users who like a certain popular film, and also to recommend independent films to users who like an artistic film, for recommendation of films of a single genre to users who like a single genre, and to recommend films of various genres to users who like various genres and to provide a personally targeted recommendation re-ranked based on a user's tendency with regard to non-personalized recommendation, advertisement, search, or the like.

Since personalization services and their applicable areas are various, aspects of the present invention provide personalized information online, mailing services, target marketing, target advertisement, and the like at various sites requiring personalization services, such as large-scale e-commerce sites or portal sites.

Although various embodiments of the present invention have been described in detail herein, it will be apparent to those skilled in the art that various changes in form and detail may be made without departing from the spirit and scope of the present invention as defined by the appended claims.

What is claimed is:

1. A method for providing a personalization recommendation service, the method comprising:
acquiring a user tendency profile and a candidate recommendation list;
re-ranking the candidate recommendation list according to the user tendency profile; and
generating a targeted recommendation list based on recommendation contents of the re-ranked candidate recommendation list.

2. The method of claim 1, wherein acquiring the candidate recommendation list includes extracting at least one candidate recommendation list previously registered.

3. The method of claim 1, wherein acquiring the candidate recommendation list includes generating at least one new candidate recommendation list corresponding to content according to a user event.

4. The method of claim 1, wherein acquiring the candidate recommendation list includes performing at least one of a personalization recommendation technique and a non-personalization recommendation technique.

5. The method of claim 1, wherein acquiring the user tendency profile includes generating the user tendency profile based on user information according to a user event and metadata of content according to the user information.

6. The method of claim 5, wherein the user information includes behavior history information, information created by user behavior, demographic data, consumption history, a favorites list, a bookmarks list, viewing history, click history, a friend list, and friend interaction content list.

7. The method of claim 1, wherein the user tendency profile is represented as one or more of user tendency distributions regarding variety, uniqueness, newness, genre, social intimacy, and popularity.

8. The method of claim 1, wherein re-ranking the candidate recommendation list includes comparing the user tendency profile and the candidate recommendation list.

9. The method of claim 8, wherein comparing the user tendency profile and the candidate recommendation list includes measuring a difference between a distribution of the user tendency profile and a tendency distribution of the candidate recommendation list.

10. The method of claim 1, wherein re-ranking the candidate recommendation list is performed based on a greedy technique.

11. The method of claim 1, wherein re-ranking the candidate recommendation list is performed using both a seed set selection algorithm for obtaining a seed set and a greedy selection algorithm for reaching a final recommendation list by iteratively selecting and replacing recommendation content candidates.

12. The method of claim 11, wherein re-ranking the candidate recommendation list includes:
selecting a seed set of targeted recommendation contents from the candidate recommendation list;
further selecting top-ranked recommendation contents from remaining recommendation content candidates; and
replacing the recommendation contents in the seed set.

13. The method of claim 12, further comprising:
determining whether the number of recommendation contents in the seed set satisfies an objective function;
if the number of recommendation contents in the seed set satisfies the objective function, performing the replacement; and
if the number of recommendation contents in the seed set does not satisfy the objective function, performing further selection.

14. The method of claim 13, further comprising:
testing all replacement cases by comparing the recommendation contents selected as the seed set with the remaining contents; and
if there is no content to be replaced, forming the targeted recommendation list from a set of recommendation contents containing the further selected contents.

15. A system for providing a personalization recommendation service, the system comprising:
a server Application Programming Interface (API) configured to receive an event for a targeted personalization service from a client;
a user profile generator configured to generate a user tendency profile based on user information according to the event and metadata of contents; and
a recommendation engine configured to generate a candidate recommendation list based on the user tendency profile and to generate a targeted recommendation list by re-ranking the candidate recommendation list based on the user tendency profile.

16. The system of claim 15, wherein the user profile generator comprises:
a behavior profile generator;
a content profile generator; and
a tendency profile generator,
wherein the user profile generator is further configured to generate the user tendency profile from demographic data, consumption history, a favorites list, a bookmark list, viewing history, click history, a friend list, and a friend interaction content list.

17. The system of claim 15, wherein the recommendation engine comprises:
a personalization type recommendation engine;
a non-personalization type recommendation engine; and
a tendency filtering engine,
wherein the recommendation engine is further configured to generate the candidate recommendation list based on at least one of the personalization type recommendation engine and the non-personalization type recommendation engine, and is further configured to generate the targeted recommendation list by re-ranking the candidate recommendation list according to the user tendency profile based on the tendency filtering engine.
